(19) United States
(12) Patent Application Publication
(10) Pub. No.: US 2006/0127572 A1
(43) Pub. Date: Jun. 15, 2006

(54) Method for producing a bituminous mix, in particular by cold process, and bituminous mix obtained by said method

(76) Inventor: Gilbert Raynaud, Muret (FR)

Correspondence Address: YOUNG & THOMPSON, 745 SOUTH 23RD STREET, 2ND FLOOR, ARLINGTON, VA, 22202, US

(21) Appl. No.: 10/535,197

(22) PCT Filed: Nov. 20, 2003
(86) PCT No.: PCT/FR03/03439

§ 371 Date: May 18, 2005

(30) Foreign Application Priority Data
Nov. 21, 2002 (FR) 02/14603

(51) Int. Cl. B05D 7/00

(52) U.S. Cl. 427/212

(57) ABSTRACT

The invention concerns a method for making a granular road surfacing material, which consists: in using at least two different granular fractions, a coarse granular fraction consisting of large and/or medium aggregates and fine granular fraction consisting of fine aggregates; coating the aggregates of the coarse granular fraction with an organic binder, so as to form an organic coarse phase; mixing the aggregates of the fine granular fraction with a mineral binder and with an amount of input water, so as to form a mineral fine phase; mixing the organic coarse phase and the mineral fine phase to obtain a material ready to be spread or stored. The organic binder is advantageously a soft bitumen emulsion, in which case the coating of the coarse granular fraction is carried out by cold process and the final mixing of the two phases is carried out preferably after break-up of the emulsion.

The invention concerns a process for producing a coated granular road material for a surface, base or foundation course, as well as the road material obtained by implementing this process. It more particularly concerns a cold process for producing a material, known as coated chippings, comprising both an organic binder as well as an inorganic binder.

Each course of a roadway principally consists of aggregates, of which the function is to form a solid skeleton withstanding stresses from traffic, and at least one binder giving this skeleton cohesion, the choice of which determines the characteristics of the course.

The difficulty of choosing the binder and aggregates comes from the fact that, within each course of a roadway, complementary and antagonistic requirements exist relating respectively to the rigidity and flexibility of the course that are indispensable for obtaining a durable result: in the case of a surface course, resistance to rutting and creep, but also flexibility, comfort for users, vehicle grip, resistance to stripping and loss of surface aggregate, and in the case of a structural course (foundation or base course), load-bearing ability and tensile strength, but also ability to deform; and in all cases, resistance to fatigue and cracking, compactness, cohesion, uniformity, durability, waterproofness, workability of the material during preparation and handling operations (mixing, transport, spreading, compacting etc).

Road materials, known as coated chippings, are first of all known based on a bituminous binder or binders. Such bituminous coated chippings have the advantage of having a relatively high ability to deform, and consequently great cracking resistance, to the detriment of their rigidity. Two main techniques exist for producing them: the technique of hot-coated bituminous coated chippings and that of cold-coated bituminous coated chippings.

Hot techniques, and particularly hot techniques for coating with pure bitumen, are perfectly controlled and make it possible to obtain stable mixtures, having good mechanical characteristics and other properties such as: adhesiveness of the bitumen, waterproofness, flexibility, comfort and grip (texture) of the coated chipping. Such a performance is however obtained at the cost of high energy consumption and a very constrictive application process (complexity of the materials used and of the operating process employed) and to the detriment of the environment (high risk of water and air pollution etc) and of the safety of persons involved in the production and spreading of these coated chippings (high temperatures—from 140° C. to 170° C.—materials, fumes, high bitumen content etc). It moreover rests on certain weak features: relative sensitivity of the road surfaces obtained to stresses from traffic (phenomena of bleeding, loss of surface aggregate, stripping and creep), which leads to a search for greater sophistication of bitumens (modified by polymers), additives and aggregates, to the detriment of economics: decreasing availability (and therefore increasing cost) of the resources; ageing of bitumen.

Cold techniques have for a long time consisted of coating aggregates with the aid of very fluid anhydrous binders, often based on cutback bitumen or tars and oils from the distillation of coal pitch. More recently, these anhydrous binders have been replaced by bitumen emulsions (a continuous aqueous phase essentially of water and an emulsifying agent in which fine particles of a bituminous phase are dispersed, consisting of pure bitumen or fluxed bitumen or bitumen cutback with the aid of petroleum solvents). Used before hot techniques but rapidly supplanted by these, cold techniques suffer from several disadvantages: low strength of the coated chippings in the early stages, on account of the random release of excess water and/or slow evaporation of solvents or fluxing media (often aromatic) used; insufficient mechanical properties for roads with heavy traffic; non-uniform results. For these reasons, the use of cold techniques is limited at the present time to small emergency repairs (holes, potholes, provisional filling of trenches etc) and to road surfaces with light traffic. Little used, these techniques are poorly controlled. They have however many advantages, in particular when they use a bitumen emulsion: simplicity of application, flexibility of use, ease of handling at ambient temperature and the rugged nature of the coated chippings, reduced cost and respect for the environment.

A desire to update cold techniques has recently been seen resulting from increasing concern for the environment. Processes have also been proposed in an attempt to offset certain disadvantages of these techniques. Accordingly, FR 2 623 219 aims to solve the problems of storing bituminous coated chippings by providing a process consisting of previously coating fine 0/2 or 0/4 elements with a slow break cationic emulsion of soft bitumen (very low viscosity) with a view to obtaining an intermediate material that can be stored, intended to be subsequently mixed with 2/D or 4/D aggregates during or at the end of coating with a hard cationic bitumen emulsion (high viscosity) that is fluxed or cutback, it being possible to store the final material obtained. With a view to reducing production costs, EP 781 887 proposes to simplify the previous process and in particular to eliminate the step of maturing or storing the intermediate material, by introducing coarse 2/D elements into a mixer with a first medium-break emulsion of a pure grade 25/35 bitumen (hard bitumen) with 180/220, or a cutback bitumen, and then adding fine 0/2 to 0/6 elements followed by a second stabilised (slow-break) emulsion of low viscosity obtained by mixing the first emulsion with an aqueous cationic agent. In addition, with a view to improving the rigidity of bituminous coated chippings, U.S. Pat. No. 5,582,639 aims to make it possible to use an emulsion of a hard bitumen (which must break before the coated chippings are transported and spread with a view to preventing problems of “washing-out” of the coated chippings) while preserving the workability of coated chippings having a soft bitumen emulsion (which can only be used for road surfaces with light traffic on account of the low rigidity that is gives the coated chippings). U.S. Pat. No. 5,582,639 assumes that the mix remains manageable as long as the fine elements are not bound with a hard bitumen and that the stones (or gravel) have not been or have not yet been coated with a hard bitumen, and therefore provides a process according to which the stones are previously coated by means of a first fast-break emulsion of a pure bitumen and then, after the first emulsion has broken, fine elements are added to the mixture as well as a second emulsion of soft bitumen that breaks at the end of the process. According to the teachings of this patent, after the coated chippings have been spread, migration occurs between the hard bitumen (high viscosity) enveloping the stones and the soft bitumen (low viscosity) to form a medium viscosity binder. The rigidity and fatigue resistance of the coated chippings obtained by these various cold processes remains however insufficient to enable them to be applied to surface courses with heavy traffic. Moreover, these processes have not made it possible to reduce significantly the consumption of bituminous binder. This objective is however a priority for obvious economic and ecological reasons.

Secondly, road materials are known based on a hydraulic binder or binders. The high rigidity of hydraulic materials constitutes at the same time their principal quality (they are preferred for this reason for producing a base or foundation course) and also their main fault: high rigidity modulus which results, on the one hand, in lack of comfort and grip when these materials are used for surface courses and, on the other hand, the appearance of fatigue fissures (cracking) under the effect of dynamic traffic stresses. Added to this are the phenomena of hydraulic shrinkage as the binder sets and thermal contraction, also responsible for the appearance of fissures. On the other hand, their insensitivity to temperature keeps them from creep and rutting phenomena from which bituminous coated chippings suffer (bitumens are in point of fact sensitive to temperature variations: brittle when cold on account of increased rigidity, they become over soft when hot).

Taking into account the respective qualities and faults of bituminous coated chippings and hydraulic materials, techniques referred to as mixed techniques have recently been developed where a hydraulic binder or binders and a bituminous binder or binders is/are blended in the same material. These mixed techniques attempt to respond to the contrary and incompatible requirements of road surfaces such as, on the one hand, the absence of cracking, flexibility, comfort, fatigue resistance, resistance to stripping and loss of surface aggregate, that are generally provided by bituminous binders and, on the other hand, the load-bearing ability, low deformation, resistance to creep and rutting that are generally provided by hydraulic binders.

Thus, EP 545 740 describes a double cold treatment process for a granular material, according to which: a premix is prepared of a granular material (0/20 for example) and a first hydraulic or bituminous binder, preferably a hydraulic binder, containing where appropriate, surface-active agent. This premix is transferred to a mixer in which a second bituminous or hydraulic binder is added, preferably a bituminous binder. EP 535 282 describes a composite binder comprising an aqueous emulsion of a bituminous binder, a hydraulic binder, and an admixture intended to control the setting rate of the hydraulic binder so as to obtain a liquid product with a viscosity below 1 Pa.s. FR 2 705 662 describes a cold coated chipping formed of a mineral skeleton (0/20 for example) associated with a binder resulting from mixing a hydraulic binder and a bituminous binder comprising a bitumen treated with short-chain amines, one or more cationic surfactants and one or more acids. FR 2 352 763 describes a process for producing a semi-rigid coating exclusively for a surface course, in which a flexible mixed mortar is blended, composed of sand, cement and a bitumen emulsion, with a supporting bituminous framework rich in cavities (mixture of coarse grains and tar, bitumen or bituminous binders).

Mixed techniques certainly provide results that are encouraging but are still unsatisfactory and inconsistent. The coated chippings obtained belong, according to which the amounts used, either to hydraulic materials of which the flexibility is improved without for all this being sufficient and comparable to that of bituminous coated chippings, or to bituminous coated chippings of which the rigidity is increased but remains too low for some uses. Moreover, it seems that partial “compensation” occurs between the respective effects of the two types of binder, which makes it essential to maintain proportions of binders that are still high and explains why the development of mixed techniques has not, at the present time, made it possible to achieve substantial economies in the quantities of binders used. It also remains to define and establish simple production protocols that are economical and easily controlled in order to make it possible to envisage the general and systematic use of these techniques.

The object of the invention is to provide a process for producing a coated granular road material based on a hydraulic binder or binders or another inorganic binder or binders and a bituminous binder or binders or another organic binder or binders, that is simple and economical and which results in coated chippings being obtained with improved mechanical characteristics.

In particular, one object of the invention is to provide coated chippings for roads having suitable flexibility, better resistance to cracking, fatigue and loss of surface aggregate and, at the same time, increased load-bearing ability, strength and resistance to stripping and creep.

Another object of the invention is to provide a process that makes it possible to obtain, according to the proportions used, a road material for a foundation, base or surface course.

Another object of the invention is to provide a cold process for producing coated chippings which preserves the advantages of cold coating techniques, in particular with a bitumen emulsion (simplicity, flexibility of use, economy and protection of the environment) and which incorporates those hot coating techniques with pure bitumen (waterproofness, adhesion, flexibility, comfort, roughness, ability to receive traffic immediately and good mechanical characteristics of the coated chippings obtained). The object of the invention is also to provide a road material that has a high degree of workability.

Another object of the invention is to provide a process that respects the environment, using reduced quantities of binders (inorganic and organic), with a desire to achieve economies, to protect the environment and to ensure the safety of persons.

To this end, the invention concerns a process for producing a coated granular road material, using at least one organic binder and at least one inorganic binder, wherein:
at least two distinct granular fractions are used, a first fraction, called a coarse granular fraction, consisting of medium and/or coarse aggregates, and a second fraction, called a fine granular fraction, consisting of fine aggregates,
the aggregates of the coarse granular fraction are coated with the organic binder so as to form a first phase, called the organic coarse phase, the term “coated” signifying that the aggregates and the binder are mixed until each aggregate is at least partially, and preferably completely, enveloped with a film of organic binder,
the aggregates of the fine granular fraction are mixed with the inorganic binder and with a quantity of makeup water, so as to form a second phase, called the inorganic fine phase,
the organic coarse phase and the inorganic fine phase are mixed so as to obtain a material that is ready to be spread or stored. It should be noted that the inorganic fine phase and the material obtained can be stored and/or worked (and in particular, as regards the final material, transported and spread over the ground to be covered and compacted) as long as the inorganic material has not set. A setting retarder for the inorganic material may advantageously be added to the inorganic binder or to the inorganic fine phase in the case of prolonged storage of the material or the said inorganic fine phase. It should be noted that the organic phase can also be stored before it is mixed with the inorganic phase.

The invention thus consists of preparing separately an organic coarse phase and an inorganic fine phase and then of mixing these together. The organic binder is consequently already fixed onto the gravel (the term “gravel” hereinafter denotes aggregates of the coarse granular fraction) when the two phases are mixed, so that it is not “absorbed” or only slightly absorbed by the inorganic fine phase (sand mortar). The inventor believes, from first principles, that the setting of the inorganic binder results in the formation of agglomerates of hardened mortar (fine aggregates+inorganic binder) filling the voids between the coated gravel, so that the two binders do not mix (contrary to the effect sought by U.S. Pat. No. 5,582,639, to the basic principles of the mixed techniques of EP 535 282 or FR 2 705 662 or FR 2 352 763, and to the results provided by all the prior processes). The inorganic fine phase and the organic coarse phase coexist and cooperate without mixing together, bound to each other by a flexible organic film (such as a bitumen film) that adheres to the gravel of the coarse phase and penetrates only very slightly into the hardened mortar agglomerates of the fine phase so as to grip them. It should be noted however that slight impregnation of the mortar agglomerates by the organic binder may be desired and obtained with an excess of organic binder, for reasons explained further on.

In this way, a particularly dense inorganic skeleton is obtained of gravel and hardened mortar aggregates, cohesion of which is provided by the flexible organic binder. The resulting material is at the same time astonishingly rigid and flexible. Rigidity, load-bearing ability and resistance to stripping are provided by the density of the inorganic skeleton (a very low percentage of voids, the spaces between the gravel being filled with mortar) and the presence of hardened mortar agglomerates (the rigidity modulus of which is very high). The compact assemblies (gravel and mortar agglomerates) forming the inorganic skeleton are elastically bound, such as by articulations (swivel effect) from an organic film, which gives the resulting material cohesion, flexibility, deformability and fatigue resistance, opposes the occurrence of cracks and exhibits, by virtue of its fineness, low sensitivity to temperature variations. Each phase plays its natural part fully, without the effects of each binder being reduced or negated by the presence of the other binder.

The quantity of organic binder is adjusted according to the destination of the material and the nature of the aggregates used, so as to obtain the specific characteristics of the course under consideration, according to its nature, the class of road, climatic constraints etc. It should be sufficient to enable the coarse and/or medium aggregates to be coated and to bind them together and to the agglomerates of hardened mortar, as well as to ensure the workability of the mixture and to give the final mixture the required qualities of flexibility, elasticity, waterproofness and resistance to fatigue, cracking and loss of surface aggregate. This quantity should at the same time be minimised so as to avoid the risks of resoftening and bleeding. The inventor has shown that the process according to the invention makes it possible to reduce significantly and surprisingly the quantity of organic binder.

When the material is intended for the production of a surface course, an excess amount of organic binder may be useful in order to bring about, during the compacting of the material spread over the ground to be covered, penetration of the organic binder into the mortar agglomerates in the process of hardening (producing, within the inorganic fine phase, a rigidity gradient crossing the surface towards the core of hardened mortar agglomerates). This penetration contributes to the binding of gravel and agglomerates on the surface of the surface course in order to improve resistance to loss of surface aggregate under traffic, and contributes to the self-repair of any disruption, and to cracking resistance.

When the material is intended for the production of a structural course, a slight excess (less than the preceding amount) of organic binder may also be useful in order to bring about, during compacting of the material spread over the ground to be covered, a slight penetration of the organic binder into the mortar agglomerates in process of hardening, which contributes to the self-repair of any disruption, and to cracking resistance.

It should be noted that the coarse granular fraction can be coated hot. Advantageously and according to the invention, it is coated cold, that is to say by means of an organic binder at ambient temperature.

Advantageously and according to the invention, the fine granular fraction used has a particle size distribution 0/d (agglomerates with a maximum size between 0 and d mm) with d comprised between 2 and 4 mm. It preferably includes 15 to 25% of elements with a size below 80 μm.

Advantageously and according to the invention, the coarse granular fraction used has a particle size distribution d/D (aggregates of which the maximum sizes lie between d mm and D mm) with d comprised between 2 and 4 mm and D comprised between 6 and 20 mm. D is preferably between 6 and 14 mm for a material for a surface course and between 10 and 20 mm for a material for a structural course.

For economic reasons, a coarse granular fraction is used consisting of locally available aggregates and the nature of the organic binder is adapted to that of the aggregates used. It should be noted that a significant percentage of round or semi-crushed material may be advantageously added to the crushed aggregates to form the coarse granular fraction, with a view to increasing the workability of the organic coarse phase and of the final material. The organic binder is chosen for its wettability and its adhesiveness (active and passive) which depend on the nature of the aggregates used, as well as for its cohesiveness.

Advantageously and according to the invention, use is made, as an organic binder, of a binder chosen from pure bitumen, fluxed bitumen, cutback bitumen, in particular bitumen cutback by means of a vegetable oil or a plasticizing dope, an emulsion of pure bitumen, an emulsion of a fluxed bitumen, an emulsion of a cutback bitumen, a pure bitumen foam, a fluxed bitumen foam, a cutback bitumen foam (the preceding binders mentioned consisting of bituminous binders), a thermoplastic resin, a thermoplastic resin emulsion, a thermosetting resin, a thermosetting resin emulsion, and for example an acrylic resin, a resin based on monomers and/or polymers of ethyl vinyl acetate, a resin based on monomers and/or polymers of styrene butadiene styrene, the said resins being used directly or in an emulsion, or a mixture of several of the aforementioned organic binders.

It should be noted that the use of a pure bitumen or a bitumen foam requires a previous step of heating the binder and aggregates, whereas the use of one of the other organic binders mentioned makes it possible to coat the coarse granular fraction cold (that is to say at ambient temperature, without heating).

The organic binder may also contain a monomer and/or polymer and/or a plasticising dope and/or an inorganic additive adapted so as to reinforce its adhesiveness to the aggregates, and/or to modify its viscosity for the purpose of better workability and better cohesiveness, and/or to accelerate the breaking of the emulsion when this is used. The organic binder may also contain an organic additive, of the latex or rubber type (in particular from used tyres) with a view to increasing the flexibility of the material obtained.

As an organic binder, use is preferably made of an emulsion (and in particular a bitumen emulsion), in which case, according to the invention, the breaking of the emulsion in the organic coarse phase is waited for or brought about before the organic coarse phase and the inorganic fine phase are mixed.

Advantageously and according to the invention, use is made of a fast- or medium-break emulsion (of bitumen for example) as an organic binder, having a break index adapted so that the emulsion breaks as soon as all the aggregates of the coarse granular fraction are wetted by the emulsion. In particular, a bitumen emulsion is used with which breaking occurs approximately at the end of 45 to 90 seconds, and preferably a minute, from mixing and blending the coarse granular fraction and the bitumen emulsion (desired mixing duration at the end of which all the aggregates should be suitably wetted and the mixture homogeneous).

In particular, advantageously and according to the invention, use is made, on the one hand, of a coarse granular fraction with a silico-calcic base and, on the other hand, as an organic binder, an emulsion (of bitumen for example) containing at least one cationic emulsifying agent and at least one amphoteric emulsifying agent. In particular, an emulsion is used of which the emulsifying agents comprise 20 to 60% cationic agents and 80 to 40% amphoteric agents. The presence of agents of a different nature facilitates the breaking of the emulsion when it is mixed with the coarse granular fraction and promotes cohesiveness of bitumen by a polar bond between its globules. It is also possible to use an emulsion containing at least one anionic emulsifying agent and at least one amphoteric emulsifying agent, with a coarse granular fraction having a basic (lime) character.

As a variant, a more stable emulsion is used (of bitumen for example) and breaking of the emulsion is brought about on demand, before or preferably after wetting of all the aggregates of the coarse granular fraction by the emulsion, by means of a composition, called the breaking composition, having a basic character in the case of an emulsion having a cationic character, chosen from lime water, a composition based on powdered quick or slaked lime, a composition based on an inorganic binder and in particular a binder based on metakaolin and lime. In the case of an emulsion having an anionic character, the chemical nature of the breaking composition should be acidic in character. The breaking composition is for example sprayed onto the organic coarse phase. However, too stable an emulsion should not be used, since this risks making breaking difficult in spite of the use of a breaking composition.

Advantageously and according to the invention, use is made, as an organic binder, of a soft bitumen (pure or in the form of an emulsion or foam) with a penetrability greater than or equal to 60/70, and preferably greater than or equal to 70/100, with a view to obtaining an organic coarse phase that is workable, cohesive and flexible. The bitumen is chosen according to climatic constraints, that is softer as the climate is cold and vice versa.

It should be noted that coating coarse and/or medium aggregates with the aid of bitumen is contrary to the teachings of FR 2 623 219, EP 781 887 and U.S. Pat. No. 5 582 639, which recommend the opposite, of coating coarse aggregates by means of a hard bitumen emulsion with a view to improving the rigidity of the coated chippings and of associating fine aggregates with a soft bitumen emulsion so as to preserve the workability of the material. This association is unfortunate taking into account the large specific surface area of the fine aggregates. It brings about a high binder consumption without providing the material with mechanical properties.

In the invention, the inorganic binder advantageously replaces the soft bitumen formerly used in the fine fraction. The result provides two main advantages: on the one hand substantial savings of organic binder and the possibility of increasing the percentage of elements with a size below 80 μm (these elements provide the final material with compactness, waterproofness, durability etc) since the organic binder is associated with a granular fraction with low specific surface area and is not absorbed by the fine granular fraction; and, on the other hand, the possibility of using a soft bitumen for the coarse granular fraction since the inorganic fine phase formed provides the material with the desired rigidity by filling the voids between the coarse and/or medium aggregates by particularly hard mortar agglomerates. The use of such a bitumen, particularly in the form of an emulsion, simplifies and facilitates the implementation of the process and makes it possible to eliminate a step of heating the bitumen without bringing about a reduction in the quality of the coating and the mechanical properties of the material obtained. The advantages of hot coating techniques are preserved within the framework of a cold process according to the invention.

Advantageously and according to the invention, the bitumen emulsion used contains 50 to 70%, preferably 65%, of bitumen by weight of emulsion.

Advantageously and according to the invention, in order to produce a road material for a surface course, use is made, as an organic binder, of a hydrocarbon binder based on bitumen in a quantity such that the weight of residual bitumen after mixing the organic coarse phase with the inorganic fine phase, lies between 1.5 and 4.5%, preferably between 2.5 and 3.5%, of the total weight of dry aggregates. It should be noted that the term “dry aggregates” denotes aggregates with fine and coarse granular fractions and particles of inorganic binder. The inventor estimates that these quantities lead to the presence of a slight excess of bitumen in the surface course, preventing premature loss of surface aggregate from the said course (excess bitumen impregnating the mortar agglomerates over a certain thickness from their surface).

In order to produce a road material for a structural course (base or foundation course), use is preferably made, as an organic binder, of a hydrocarbon binder based on bitumen, in a quantity such that the weight of residual bitumen after mixing the organic coarse phase and the inorganic fine phase lies between 0.5 and 2.5%, preferably between 1 and 2%, of the total weight of dry aggregates.

These values are much lower than former normal amounts. They seem to be explained, from first principles, by the fact that according to the invention, in the final mix, the organic binder only penetrates slightly into the fine phase and substantially coats the compact assemblies (coarse and/or medium aggregates and mortar agglomerates) that have a low specific surface area. It should be noted that it is not useful, if the material is intended for producing a structural course, to provide quantities of binder leading to a significant overdose of residual bitumen.

Taking into account the relatively low proportions recommended according to the invention, a bitumen is preferably used with a high wettability and filmability coefficient, with a view to obtaining good coating of the aggregates of the coarse granular fraction. When a bitumen emulsion is used, the proportions of water and emulsifiers in it are chosen as a function of the quantity of useful water for the final mixture and also so as to facilitate coating of the coarse aggregates and breaking of the emulsion.

As a variant or in combination, the aggregates of the coarse granular fraction are pre-wetted with water before they are coated. This operation may be combined with, or replaced by, a first washing (before coating) of the aggregates of the coarse granular fraction, the objective of which is to remove any fine particles (dust) existing in this fraction, with a view to increasing the wettability and adhesiveness of the bitumen. The fines removed are recovered and incorporated in the inorganic fine phase by recycling the wash water to the said inorganic fine phase. They participate in the total percentage of elements below 80 μm.

As a variant or in combination, coating the coarse granular fraction with organic binder is performed in several steps: the coarse aggregates are mixed with the organic binder so as to obtain partial coating of the coarse aggregates, the medium aggregates are then added and everything is mixed until the coarse and medium aggregates are completely coated).

The adhesiveness of bitumen to the coarse and/or medium aggregates depends on the viscosity of the bitumen, its affinity for the aggregates (different according to the nature of the latter) which is facilitated by pre-wetting, and on the formulation of the emulsion (presence of any dopes) when this is used.

Advantageously and according to the invention, the aggregates of the coarse granular fraction are lacquered, before being coated, with an inorganic composition, called the lacquering composition, chosen from lime water, a composition based on powdered quick or slaked lime, a composition based on an inorganic binder and in particular a binder based on metakaolin and lime, or by means of any inorganic or organic lacquering composition with a chemical nature (acidic or basic) different from that of the organic binder. The lacquering composition is used in a quantity such that it comprises a weight of dry matter between 0.5 and 2% of the total weight of dry aggregates. Such lacquering contributes to the breaking of the bitumen emulsion when this is used. It moreover increases the adhesiveness of the residual bitumen to the aggregates and its ageing resistance and improves its cohesiveness and its immediate and subsequent viscosity at extreme temperatures, promoting in this way the resistance of the final mixture to cracking, rutting and fatigue, and hence its durability. This operation may be combined with a pre-wetting of the said aggregates. The term “lacquering” signifies that the lacquering composition is mixed with the aggregates so as to wet the surface of the aggregates with the composition and/or to cover the surface of the aggregates with a film of the composition. Recycling excess lacquering composition in the inorganic fine phase advantageously causes the said composition to participate in hydraulic setting.

As a variant, advantageously and according to the invention, there is introduced progressively into the organic coarse phase as it forms (a little while after the aggregates and organic binder have been put into contact and during the step of blending the organic phase, before the two phases are mixed), an inorganic composition, also called a lacquering composition, chosen from lime water, a composition based on powdered quick or slaked lime, a composition based on an inorganic binder and in particular a binder based on metakaolin and lime, or by means of any inorganic or organic lacquering composition with a chemical nature (acidic or basic) different from that of the organic binder. This operating method provides novel advantages such as control over the breaking of the emulsion, better wettability, increased workability through an increase in temperature when quicklime is used, and the absorption of free water from the composition.

Advantageously and according to the invention, use is made, as an inorganic binder, of a binder chosen from a cement (Portland cement, composite Portland cement, blast furnace cement, slag and ash cement, pozzolan cement etc), a composite road binder, an activated pozzolan binder based on blast furnace slag, blast furnace slag fines, calcined clays, pozzolan fines, silico-aluminous or sulfo-calcic fly ash, or a mixture of the preceding compounds.

A mixture based on metakaolin and lime (pozzolan binder) is preferred for its high hardening power, its slow set which limits the risk of cracks appearing, its high activity index, its capacity to absorb heavy metals, its workability and its natural environmental character. It is particularly recommended if a bitumen emulsion is used as the organic binder, taking into account its affinity for water, and therefore its capacity to absorb water from the emulsion. A powdered composition is preferably used comprising 50 to 70% by weight of metakaolin and 30 to 50% by weight of lime, as well as various possible additives. Such a composition may also act as a lacquering composition, mixed with the coarse granular fraction prior to its being coated or throughout this. The excess coming from lacquering is recycled as an inorganic binder for the fine phase.

The inorganic binder used is preferably in powdered form, the water necessary for subsequent setting coming from the natural water of the aggregates and the makeup water, as well as from the emulsion (when used), water for washing and/or for pre-wetting the gravel (when such an operation is carried out) and from the composition for lacquering the gravel (when such an operation is carried out). The powdered inorganic binder is mixed as it is to the fine granular fraction and makeup water. As a variant, the inorganic binder is mixed with all or part of the makeup water before it is mixed with the fine granular fraction.

The quantity of makeup water to be added is adjusted so that the total quantity of available water in the final mixture (makeup water and as the case may be water from the emulsion and/or water for pre-wetting and/or lacquering the gravel) is mainly, and preferably entirely, consumed by the chemical reaction with the inorganic binder, with a view to obtaining good strength at an early stage and to allow traffic to pass immediately. A quantity of residual water in the final mixture of inorganic fine and organic coarse phases not exceeding 2% by weight of the said mixture is tolerated. The quantity of makeup water used varies between 2% and 8% of the total weight of dry aggregates.

The quantity of inorganic binder is adjusted according to the destination of the material, so as to obtain specific characteristics for the course under consideration, according to its nature, the class of roadway, climatic constraints etc. It should, on the other hand, be sufficient to enable a homogeneous mixture to be produced with the fine granular fraction, in order to stabilise the fine aggregates (in corresponding locations) in the form of agglomerates adhered to coarse and/or medium aggregates by the organic binder, and to provide the final material with the required qualities of rigidity, compactness, load-bearing ability and resistance to rutting and creep. It should, on the other hand, be minimised so as to prevent a final material from being obtained that is too rigid.

Therefore, advantageously and according to the invention, in order to produce a road material for a surface course, a quantity of inorganic binder is used of between 2and 5%, preferably approximately 2.5 to 4.5% of the total weight of dry aggregates. The values provided concern the initial dry form (powdered) of the inorganic binder, whether this be added to the fine granular fraction in powdered form or mixed with the makeup water. In order to produce a material for a structural (base or foundation) course, a quantity of inorganic binder is used of between 2 and 8%, and in particular approximately 3 to 5%, of the total weight of dry aggregates. These values are less than previous normal proportions.

Setting of the inorganic binder is exothermal and contributes to the workability and adhesiveness of the phases and to the slight penetration of excess bitumen into fine phase (by softening it) if an excess proportion of bitumen is provided (in particular for a surface course).

It should be noted that, if the material is not intended to be stored but is produced with a view to its being spread immediately or within a short time, a dope for accelerating setting may be optionally used to improve its strength at an early stage and its ability to receive traffic immediately, to promote the formation and stability of hardened mortar agglomerates and to prevent any undesirable. migration of bitumen or of another organic binder to the inorganic fine phase (in the case of insufficient adhesion of this to the coarse aggregates).

The respective percentages of each of the two binders varies according to the destination of the material. Thus, the quantity of organic binder of a surface course is advantageously greater than that of a structural course. Indeed, more organic binder is needed in order to meet the requirements of flexibility, deformability, comfort, waterproofness, resistance to stripping and loss of surface aggregates for the surface course, than is necessary in the structural course for enabling the rigidity modulus to be reduced to a suitable value and to overcome risks of cracking. Contrary to this, the quantity of inorganic binder of a structural course is advantageously greater than that of a surface course, in order to provide the structural course with load-bearing ability and deformation resistance. Small quantities are moreover sufficient for providing the surface course with cohesion and resistance to rutting.

Thus, the further away from the surface of a roadway according to the invention, the more the percentage of organic binder diminishes and the more the percentage of inorganic binder increases. However, according to the invention, the total percentage of the two binders, on the total weight of dry aggregates, remains substantially the same in all points of the roadway; that is to say it remains the same for a material for the surface course as for a material for the structural course.

It should be noted that, in all previous processes, hydraulic binders are used as more or less rigidifying “fillers” (fine particles designed to fill microscopic voids existing in the material). In the invention, the fine granular phase and the inorganic binder participate in the framework of the inorganic skeleton by filling macroscopic voids (and possibly microscopic voids) between the gravel particles. The fine and coarse granular fractions are calibrated and metered so that in the final mixture the gravel particles have at least one face in contact and that the hardened mortar agglomerates fill the voids between the gravel particles as exactly as possible without separating them. The smallest possible percentage of the fine granular fraction (and of the inorganic binder etc) is therefore used. Advantageously and according to the invention, the coarse granular fraction used represents 55 to 70% of the total weight of the fine and coarse granular fractions.

Advantageously and according to the invention, the fine granular fraction and the inorganic binder together comprise between 6 and 15%, preferably between 8 and 12%, of elements with a size less than 80 μm, on the total weight of dry aggregates, so as to increase the compactness of the material obtained. These percentages, higher than those formerly recommended, enable a particularly dense inorganic phase to be obtained that will more easily fill the voids in the organic coarse phase.

The invention extends to coated granular road materials obtained by a process according to the invention, as well as to structural and surface courses and to roadways produced from such materials.

The invention also concerns a process for producing a coated granular road material characterized in combination or in part by the characteristics mentioned above and hereinafter.

Other objects, characteristics and advantages of the invention will become apparent on reading the examples of embodiments below, provided in a non-limiting manner.

### EXAMPLE 1

A coated granular road material was prepared, according to the invention, for a structural course, comprising:

| | | |
|---|---|---|
| Coarse granular fraction: | Medium 2/6 C aggregates | 17.0% |
| | Coarse 6/14 C aggregates | 42.0% |
| Fine granular fraction: | 0/2 F sand | 26.0% |
| | 0/2.5 R sand | 11.0% |
| Pozzolan binder | | |
| (inorganic binder): | Metakaolin | 2.4% |
| | Lime | 1.6% |
| | (Total dry aggregates) | 100% |

| | |
|---|---|
| Bitumen emulsion (organic binder) containing | |
| 65% of bitumen with 70/100 penetrability | 4.0% |
| (that is a percentage residual bitumen of 2.6%) | |
| Makeup water | 5.5% |

The theoretical particle size distribution of the M1 dry aggregates (fine and coarse granular fractions and pozzolan binder) is below as an indication:

| Sieve in mm | % passing |
|---|---|
| 20 | 100.00 |
| 16 | 99.0 |
| 14 | 96.9 |
| 12.5 | 93.2 |
| 10 | 83.1 |
| 8 | 71.6 |
| 6.3 | 60.5 |
| 4 | 49.8 |
| 2 | 38.4 |
| 1 | 28.6 |
| 0.5 | 20.8 |
| 0.315 | 15.5 |
| 0.2 | 12.0 |
| 0.08 | 7.66 |

It should be noted that the percentage of elements with a size below 80 μm (which includes the inorganic binder) is situated within the low range of what is specified according to the invention (between 6 and 15%). In spite of this, the compactness of the M1 material obtained proved to be very suitable (see the results of tests on-site reported below). A higher percentage of elements below 80 μm should make it possible to improve further still the compactness of the material and, in so doing, to improve its resistance to rutting, its waterproofness and its durability etc. To this end, the 0/2.5 R round sand specified in the formulation for M1 could be replaced by a 0/2 F fillerized sand without any noticeable effect on the workability of the inorganic fine phase and of the final material.

The material, reference M1, was prepared by the following process: the 2/14 coarse granular fraction and the bitumen emulsion were mixed in a normal type of blender, while adding a small proportion of makeup water if necessary. Simultaneously or consecutively, the 0/2 fine granular fraction (0/2 F sand and 0/2.5 R sand) and the mixture of metakaolin and lime were mixed in a normal type of blender or mixer. When a homogeneous mix was obtained between the coarse granular fraction and the bitumen emulsion (that is approximately after one minute's mixing), the two phases previously obtained were mixed with the remaining water. To this end, the fine inorganic phase and the makeup water were incorporated in the first blender containing the organic coarse phase (first operating mode) or the makeup water and the organic coarse phase were incorporated in the second blender containing the fine inorganic phase (second operating mode) or the two phases and the makeup water were tipped simultaneously into a third blender (third operating mode). The M1 material in the example was prepared according to the first operating mode. It should be noted that the organic coarse phase and the inorganic fine phase could be prepared successively in the same blender (the phase prepared first of all being temporarily stored during preparation of the second phase), in which the final mixing is also carried out.

It should be noted that the final mixture between the two phases is preferably prepared after the bitumen emulsion has completely broken. In the present example, the emulsion used was a medium-break emulsion and breaking was not totally achieved when the two phases were mixed, so that part of the bitumen was not yet fixed onto the gravel during final mixing. The inventor had however taken this phenomenon into account by providing a relatively high amount of bitumen emulsion (2.6% of residual bitumen). Use of a fast break emulsion should easily make it possible to reduce this amount to 1.5 or 2%.

Test n° 1 in the Laboratory on the Material of Example 1:

Starting with the M1 material, specimens were prepared 16 cm in diameter and 16 cm in height (Φ16 h16), which were crushed after 28 days, according to the method described in NF P 98-232-3 “Diametral compression test on materials treated with hydraulic and pozzolan binders”.

The indirect tensile strength R_{tb} (corresponding to the diametral compressive strength of the material) and the elastic modulus Et_{b} (also called the rigidity modulus, corresponding to the secant modulus at 30% of the diametral compressive strength of the material) of these specimens were measured and calculated according to this same standard. The results are as follows:
R_{tb}=0.27 Mpa
E_{tb}=7223 Mpa

The M1 material according to the invention advantageously had an elastic modulus E_{tb} below that of known gravel cements normally used for structural courses (which varies between 20 000 and 40 000). It therefore had fewer risks of cracking and fracture than these previous materials.

It should be noted that NF P 98-232-3, which applies to hydraulic materials, has been transposed to the mixed material according to the invention in the absence of a specific standard capable of defining the mechanical performance of such a material. The results obtained should therefore be analysed with some discretion. This is why their interpretation has been verified by establishing an experimental site and by observing changes to this site.

### EXAMPLE 2

A coated granular road material was prepared, according to the invention, for a top course, comprising:

| | | |
|---|---|---|
| Coarse granular fraction: | Medium 2/6 C aggregates | 17.0% |
| | Coarse 6/10 C aggregates | 42.0% |
| Fine granular fraction: | 0/2 F sand | 27.5% |
| | 0/2.5 R sand | 11.0% |
| Pozzolan binder | | |
| (inorganic binder): | Metakaolin | 1.5% |
| | Lime | 1.0% |
| | (Total dry aggregates) | 100% |

| | |
|---|---|
| Bitumen emulsion (organic binder) containing | |
| 65% of bitumen with 70/100 penetrability | 6.0% |
| (that is a percentage residual bitumen of 3.9%) | |
| Makeup water | 5.5% |

The theoretical particle size distribution of the M2 dry aggreates (fine and coarse granular fractions and pozzolan binder) is given below as an indication:

| Sieve in mm | % passing |
|---|---|
| 12.5 | 100.00 |
| 10 | 96.4 |
| 8 | 78.6 |
| 6.3 | 61.4 |
| 4 | 48.4 |
| 2 | 38.2 |
| 1 | 28.0 |
| 0.5 | 19.6 |
| 0.315 | 14.6 |
| 0.2 | 10.9 |
| 0.08 | 6.77 |

As previously explained for M1, the percentage in M2 of elements with a size below 80 μm (which includes the inorganic binder) is situated within the low range of what is specified according to the invention. In spite of this, the compactness of the M2 material obtained proved to be very suitable (see the results of tests on-site reported below). A higher percentage of elements below 80 μm should make it possible to improve further still the compactness of the material and, in so doing, to improve its resistance to rutting, its waterproofness and its durability etc.

The material, reference M2, was prepared by the following process: the 2/10 coarse granular fraction and the bitumen emulsion were mixed in a normal type of blender. Simultaneously or consecutively, the 0/2 fine granular fraction (0/2 F sand and 0/2.5 R sand) and the mixture of metakaolin and lime were mixed in a normal type of blender or mixer. When a homogeneous mix was obtained between the coarse granular fraction and the bitumen emulsion (that is approximately after one minute's mixing), the two phases previously obtained were mixed with the makeup water according to the operating modes described in example 1.

The final mixture between the two phases is preferably prepared after the bitumen emulsion has completely broken. In the present example, the emulsion used was a medium-break emulsion and breaking was not totally achieved when the two phases were mixed. The recommended proportion of bitumen emulsion (3.9% of residual bitumen) could easily be reduced to 2.5 or 3% by using a fast break emulsion.

Test n° 2 in the Laboratory on the Material of Example 2:

The water content and the percentage voids of the M2 material, for a given temperature and compactness, were determined according to standard NF P 98-251-4 “Duriez test on cold bituminous mixes with bitumen emulsion”.

The Duriez test makes it possible to illustrate the behaviour of the material faced with attack from water, and therefore to estimate the adhesiveness of bitumen and the resistance of the material to stripping.

Starting with the M2 material, 80 mm diameter specimens were prepared by double action static compacting. The apparent density AD of said specimens was determined by hydrostatic weighing and the percentage voids in the material, the simple compressive strength R of specimens after holding in air for 14 days at 18° C. and 50% relative humidity, and the simple compressive strength r of specimens after holding in air for 7 days at 18° C. and 50% relative humidity, and then immersing in water for an additional 7 days also at 18° C., the water resistance of the material being expressed by the ration r/R. The results are as follows:
r=4.77 Mpa
R=5.66 Mpa
r/R=0.84
AD=2258 g/cm³
% voids=10.8
The simple compressive strength and water resistance of the M2 material were completely satisfactory and enabled good performance of the material with time to be forecast (cohesion, low wear etc).
Establishing a Site with the Materials of Examples 1 and 2 and Consecutive Tests:

The pavement of a road leading to a waste collection centre, subject to heavy traffic from large-tonnage vehicles, was constructed as follows:
a 5 cm thickness of 0/20 aggregates was spread onto the substrate to rectify any unevenness,
no foundation or base course was constructed,
adjacent top courses, 9 to 10 cm thick, were constructed (directly on the substrate, or more exactly on the course of aggregates covering the latter) by means of:
   M1 material according to the invention (material for a structural course), over a first third of the length of the road defining a section S,
   M2 material according to the invention (material for a surface course), over a second third of the length of the road defining a section P,
   Material A2 over the last third of the length of the road defining a section Q. Said material A2 possessed a similar formula to that of M2 (with the exception of the proportion of bitumen emulsion) but was produced by a former process. The material A2 was actually produced by mixing simultaneously all of its constituents in a normal type mixer in a single step.

The formula of the material A2 is given below

| | | |
|---|---|---|
| Coarse granular fraction: | Medium 2/6 C aggregates | 17.0% |
| | Coarse 6/10 C aggregates | 42.0% |
| Fine granular fraction: | 0/2 F sand | 27.5% |
| | 0/2.5 R sand | 11.0% |
| Pozzolan binder | | |
| (inorganic binder): | Metakaolin | 1.5% |
| | Lime | 1.0% |
| | (Total dry aggregates) | 100% |

| | |
|---|---|
| Bitumen emulsion (organic binder) containing | |
| 65% of bitumen with 70/100 penetrability | 8.5% |
| (that is a percentage residual bitumen of 5.5%) | |
| Makeup water | 5.5% |

It should be noted that the aggregates used for producing A2 had the same provenance, nature and particle size distribution as those used for producing M2. Similarly, the inorganic binder for A2 was identical to the inorganic binder of M2 and was employed in the same proportions (on the total weight of dry aggregates). The bitumen emulsion for A2 was also that of M2 but it was added in a much greater proportion in A2 in order to compensate for its partial “absorption” by the sand and inorganic binder during mixing.

It should also be noted that the roadway was produced under extreme conditions: unfavourable weather (heavy rain), waterlogged bed, pools of water on the banks, mediocre bearing ability of the substrate, and immediate heavy traffic. It was moreover subjected to particularly severe conditions of use: continual heavy traffic (2384 vehicles—8097 axles—per month in both directions, 73 000 tonnes in the entering direction, 30 000 tonnes in the leaving direction) and heavy contamination of the top course (mud carried by the wheels of trucks). Finally, the top courses were all the more vulnerable as they were not supported by a foundation course or by a base course or by side shoulders.

From visual observations made on the roadway two and three weeks after it was produced, it emerged that:
cores were taken on sections S and P at 14 days,
it was only possible to take cores on the section Q at the end of the third week,
sections S and P according to the invention behaved well under traffic,
section Q had ruts in the direction that trucks entered,
sections S and P had a good texture and offered a favorable impression as regards loss of surface aggregate,
section Q was subject to loss of gravel in the region of tyre treads.

In order to confirm these initial impressions, cores were taken on each section and then aged for 3 months in order to determine, on the one hand, compactness, and on the other hand, mechanical properties according to standard NF P 98-232-3 (see Test n° 1 above). The results are as follows:

Section S (material M1 according to the invention for the structural course):
TD=2548 g/m³ (true density)
AD=2343 g/m³ (apparent density)
Compactness=91.9% (that is 8.1% voids)
R_{tb}=1.05 Mpa
E_{tb}=6725 Mpa
Section P (material M2 according to the invention for the top course):
TD=2502 g/m³
AD=2279 g/m³
Compactness=91.1% (that is 8.9% voids)
R_{tb}=0.67 Mpa
E_{tb}=3821 Mpa
Section Q (material A2 according to a previous process, for the top course):
TD=2449 g/m³
AD=2249 g/m³
Compactness=91.8% (that is 8.2% voids)
R_{tb}=0.40 Mpa
E_{tb}=3826 Mpa

The compactness of the materials M1, M2 and A2 were entirely satisfactory.

The results concerning the mechanical properties (R_{tb} and E_{tb}) of the materials should be interpreted with caution, taking account of the fact that standardized diametral compression tests carried out do not apply to cold-coated bituminous coated chippings (they concern hydraulic materials) and are normally carried out on specimens prepared in the laboratory (according to standard NF P 98-230-1 or NF P 98-230-2) and not on cores taken on-site.

It was however found that section S according to the invention had, on the one hand, an indirect tensile strength similar to that of known gravel-cement mixtures and, on the other hand, an elastic modulus below that of known gravel-cement mixtures (usually between 20000 and 30000 Mpa). These mechanical performances reveal a material that not only preserves a suitable load-bearing capability but which is moreover free from the major defects of previous materials associated with their too high elastic modulus: considerable problems of cracking, discomfort and lack of flatness which call for the use of costly contrivances such as reinforcements, expansion joints etc.

It was moreover found that section P according to the invention combined good indirect tensile strength and a low but sufficient elastic modulus, so that the top course obtained was at the same time flexible and resistant to rutting.

On the contrary, section Q, of which the deformability was correct (suitable elastic modulus) had too low a tensile strength. Moreover, it was found that the elastic moduli of the materials M2 and A2 were of the same order while the material A2 contained a much higher percentage of residual bitumen. In other words, identical flexibility and better rutting resistance to that of section Q were obtained for section P with less bitumen. This result tends to confirm the principle stated by the inventor, according to which part of the bitumen of the material A2 (section Q) was unfavorably absorbed by the fine fraction and the inorganic binder and it was not of use for the mechanical and flexibility properties of the material.

These results approach the visual observations reported above and the following tests relating to rutting and to the macrotexture of top courses, which confirm the preceding conclusions.

Rutting measurements were taken on sections S, P and Q aged for 3 months, in highly stressed zones (strips where vehicles' wheels had passed). These measurements indicated the depth of collapse, known as the rutting depth, of the roadway under a 1 metre straightedge.

The depth of rutting of section S (structural course according to the invention) varied between 4 and 10 mm, and was on average equal to 6 mm over the track entering the waste disposal unit and 4.6 mm over the track leaving the waste disposal unit.

The depth of rutting of section P (top course according to the invention) varied between 2 and 5 mm, and was on average equal to 3.2 mm over the entering track and 2.6 mm over the leaving track.

The depth of rutting of section Q varied between 10 and 15 mm, and was on average equal to 12.5 mm.

The materials M1 and M2 according to the invention (and in particular material M2) thus displayed a very good resistance to rutting, obviously better than the material A2 prepared according to a previous process. The materials according to the invention were able to withstand immediate intense and heavy traffic.

Studies were also carried out to determine surface macrotexture of the sections P and Q, then aged for 4 months. To this end, the sand patch true texture test SPTt was measured according to standard NF P 98-216-1 at several points of the said sections.

The mean sand patch true texture test result for section S according to the invention was 0.74 (it was 0.73 on the entering track and 0.75 on the leaving track).

The mean sand patch true texture test result for the section P according to the invention was 0.61 (it was 0.60 on the entering track and 0.62 on the leaving track).

The mean sand patch true texture test result for the section Q was 0.98 on the entering track and 0.77 on the leaving track).

Although standard NF P 98-216-1 fixes no recommended range of values for SPTt, it is customary to say that a suitable roadway macrotexture should lead to a sand patch test result of between 0.6 and 0.75. Sections S and P according to the invention (and in particular section P) thus have a suitable macrotexture.

On the other hand, a SPTt result greater than 0.75, such as that of section Q, is a sign of disorder, tearing out and loss of surface aggregate of the top course, due to a too open structure of the material.

The materials according to the invention thus have increased resistance to loss of surface aggregate compared with former materials, which it has been possible to note visually.

All the tests led to the point where the inventor was able to define empirical means for estimating the quality of a material according to the invention when it is coated cold, the use of which could be generalized to all mixed materials. Thus the inventor estimates that measurements of elastic modulus and, as the case may be, indirect tensile strength, could constitute reliable indicators for the assessment of criteria relating to rigidity (load-bearing ability, resistance to rutting etc), while measurements of simple compressive strength could legitimately be used to estimate the cohesion of the materials and their ability to receive immediate traffic.

The inventor has determined, on the one hand, that a material according to the invention having an elastic modulus between 6500 and 12000 Mpa and an indirect tensile strength between 0.8 and 1.2 Mpa is particularly suitable for structural courses. He has on the other hand determined that the combination, for a material according to the invention, of an elastic modulus between 3000 and 6000 Mpa, an indirect tensile strength between 0.5 and 1 MPa and a simple compressive strength R between 5 and 8 Mpa, qualifies a material that is particularly suitable for surface courses. These ranges of values cover all classes of roadway.

It is evident that the invention may be the object of many variants relative to the previously described examples.

1-27. (canceled)

28. A process for producing a coated granular road material, using at least one organic binder and at least one inorganic binder, comprising the steps of:
using at least two distinct granular fractions, a first fraction, called a coarse granular fraction, consisting of coarse and/or medium aggregates, and a second fraction, called a fine granular fraction, consisting of fine aggregates, coating the aggregates of the coarse granular fraction with the organic binder so as to form a first phase, called the organic coarse phase,
mixing the aggregates of the fine granular fraction with the inorganic binder and with a quantity of makeup water, without an organic or synthetic additive, so as to form a second phase, called the inorganic fine phase, and
mixing the organic coarse phase and the inorganic fine phase so as to obtain a material that is ready to be spread or stored.

29. A process as claimed in claim 28, wherein the coarse granular fraction is coated cold.

30. A process as claimed claim 28, wherein the coarse granular fraction has a particle size distribution d/D, with d comprised between 2 and 4 mm and D comprised between 6 and 20 mm.

31. A process as claimed in claim 28, wherein the fine granular fraction has a particle size distribution 0/d, with d comprised between 2 and 4 mm.

32. A process as claimed in claim 28, wherein use is made, as an organic binder, of a binder chosen from pure bitumen, fluxed bitumen, cutback bitumen, an emulsion of pure bitumen, an emulsion of a fluxed bitumen, an emulsion of a cutback bitumen, a pure bitumen foam, a fluxed bitumen foam, a cutback bitumen foam, a thermoplastic resin, a thermoplastic resin emulsion, a thermosetting resin, a thermosetting resin emulsion, an acrylic resin, a resin based on monomers and/or polymers of ethyl vinyl acetate, a resin based on monomers and/or polymers of styrene butadiene styrene, an emulsion of one of the aforementioned resins, or a mixture of several of the aforementioned organic binders.

33. A process as claimed in claim 32, wherein an emulsion is used as the organic binder and breaking of the emulsion in the organic coarse phase is waited for or brought about before the organic coarse phase and the inorganic fine phase are mixed.

34. A process as claimed in claim 33, wherein a fast- or medium-break emulsion is used as the organic binder, having a break index adapted so that the emulsion breaks as soon as all the aggregates of the coarse granular fraction are wetted by the emulsion.

35. A process as claimed in claim 34, wherein a coarse granular fraction is used with a silico-calcic base and, as an organic binder, an emulsion containing at least one cationic emulsifying agent and at least one amphoteric emulsifying agent.

36. A process as claimed in claim 35, wherein an emulsion is used of which the emulsifying agents comprise 20 to 60% cationic agents and 80 to 40% amphoteric agents.

37. A process as claimed in claim 34, wherein a coarse granular fraction is used with a basic character and, as an organic binder, an emulsion containing at least one anionic emulsifying agent and at least one amphoteric emulsifying agent.

38. A process as claimed in claim 33, wherein breaking of the emulsion is brought about by means of a composition, called the breaking composition, chosen from lime water, a composition based on powdered quick or slaked lime, a composition based on an inorganic binder and in particular a binder based on metakaolin and lime.

39. A process as claimed in claim 28, wherein use is made, as an organic binder, of an emulsion of a soft bitumen with a penetrability greater than or equal to 60/70.

40. A process as claimed in claim 28, for producing a road material for a surface course, wherein use is made, as an organic binder of a hydrocarbon binder based on bitumen, in a quantity such that the weight of residual bitumen after mixing the organic coarse phase with the inorganic fine phase, lies between 1.5 and 4.5% of the total weight of dry aggregates.

41. A process as claimed in claim 28, for producing a road material for a structural course, wherein use is made, as an organic binder, of a hydrocarbon binder based on bitumen, in a quantity such that the weight of residual bitumen after mixing the organic coarse phase with the inorganic fine phase, lies between 0.5 and 2.5% of the total weight of dry aggregates.

42. A process as claimed in claim 28, wherein the aggregates of the coarse granular fraction are pre-wetted with water before they are coated.

43. A process as claimed in claim 28, wherein the aggregates of the coarse granular fraction are washed, before they are coated, with a view to removing any fine particles.

44. A process as claimed in claim 43, wherein the fine particles removed are incorporated into the inorganic fine phase by recycling the wash water.

45. A process as claimed in claim 28, wherein the coarse granular fraction is coated in several steps: the coarse aggregates are mixed with the organic binder so as to obtain partial coating of the coarse aggregates, the medium aggregates are then added and everything is mixed.

46. A process as claimed in claim 28, wherein the aggregates of the coarse granular fraction are lacquered, before being coated, with an inorganic composition, called the lacquering composition, chosen from lime water, a composition based on powdered quick or slaked lime, a composition based on an inorganic binder such as a binder based on metakaolin and lime, used in a quantity such that it comprises a weight of dry matter between 0.5 and 2% of the total weight of dry aggregates.

47. A process as claimed in claim 46, wherein the excess lacquering composition is recycled in the inorganic fine phase.

48. A process as claimed in claim 28, wherein there is introduced progressively into the organic coarse phase as it forms, an inorganic composition, called a lacquering composition, chosen from lime water, a composition based on powdered quick or slaked lime, a composition based on an inorganic binder such as a binder based on metakaolin and lime.

49. A process as claimed in claim 28, wherein use is made, as an inorganic binder, of a pozzolan binder comprising 50 to 70% by weight of metakaolin and 30 to 50% by weight of lime.

50. A process as claimed in claim 28, wherein a quantity of makeup water is used such that the quantity of residual water in the mixture of inorganic fine and organic coarse phase does not exceed 2% by weight of said mixture.

51. A process as claimed in claim 28, for producing a road material for a surface course, wherein a quantity of inorganic binder is used of between 2 and 5% of the total weight of dry aggregates.

52. A process as claimed in claim 28, for producing a road material for a structural course, wherein a quantity of inorganic binder is used of between 2 and 8% of the total weight of dry aggregates.

53. A process as claimed in claim 28, wherein the coarse granular fraction represents 55 to 70% of the total weight of fine and coarse granular fractions.

54. A process as claimed in claim 28, wherein the fine granular fraction and the inorganic binder together comprise between 6 and 15% of elements with a size less than 80 μm, on the total weight of dry aggregates.
